(19) United States
(12) Patent Application Publication
(10) Pub. No.: US 2003/0133360 A1
(43) Pub. Date: Jul. 17, 2003

(54) Mounting device for effectively reproducing position sensitive acoustic drum strikes and instrument feel

(76) Inventor: Donald A. Love III, North Hollywood, CA (US)

Correspondence Address: Donald A. Love III, 11127 La Maida #28, North Hollywood, CA, 91601, US

(21) Appl. No.: 10/045,762

(22) Filed: Jan. 15, 2002

(51) Int. Cl. H04B 1/59; G10H 1/057

(52) U.S. Cl. 367/5; 367/4; 84/738

(57) ABSTRACT

A device for center positioning a piazo element for the purpose of effectively reproducing the dynamics of a drum stick strike and feel when converting acoustical drums into electronic drums.

The device is a vented cylindrical plastic unit that mounts on top of a acoustical drum rim with a foam dampening ring inserted on top of it and a cylindrical dampening ring beneath the device to dampen the bottom head. A foam pyramid is mounted on the top of a piazo element which is positioned in the center of the plastic vented mounting ring. The entire device is then placed on the drum rim and the top drum head is then attached touching the foam pyramid which allows the piazo element to receive drum impulses.

This invention relates to the field of converting acoustical drums into electronic drums while maintaining a realistic acoustic drum feel and having the ability to convert back to acoustical drums with minimal effort.

This invention's foam pyramid shape reduces the dampening effect of the trigger and the device's vented mounting ring allows for the dissipation or transfer of air pressure from the top head through the drum shell which permits the drum to retain a larger percentage of its acoustical qualities and live feel while being able to capture the drum impulses for conversion into electronic impulses. The use of the bottom head foam dampening cylinder allows for a more muted acoustical drum with out the loss of top head drum dynamics which the other triggers lack.

### SUMMARY OF THE INVENTION

The primary object of the invention is to provide a device that allows for a more effective and dynamic triggering method in which acoustic drums converted to electronic drums while still retaining a high level of selectivity in dampening qualities without losing the lively real feel of acoustic drums.

Other objects and advantages of the present invention will become apparent from the following descriptions taken in connection with the accompanying drawings.

### DESCRIPTION OF THE DRAWINGS

FIG. 1 is a perspective view of the invention disassembled (vented plastic insert tray)

FIG. 2 is a 2d view of the invention as it would be viewed through a drum shell fully assembled

FIG. 3 is a top view of the foam pyramid attached to the piazo element

FIG. 4 is a top/side view of the foam pyramid piazo element

### PREFERRED EMBODIMENTS

A detailed description of the preferred embodiment is provided herein. However, the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

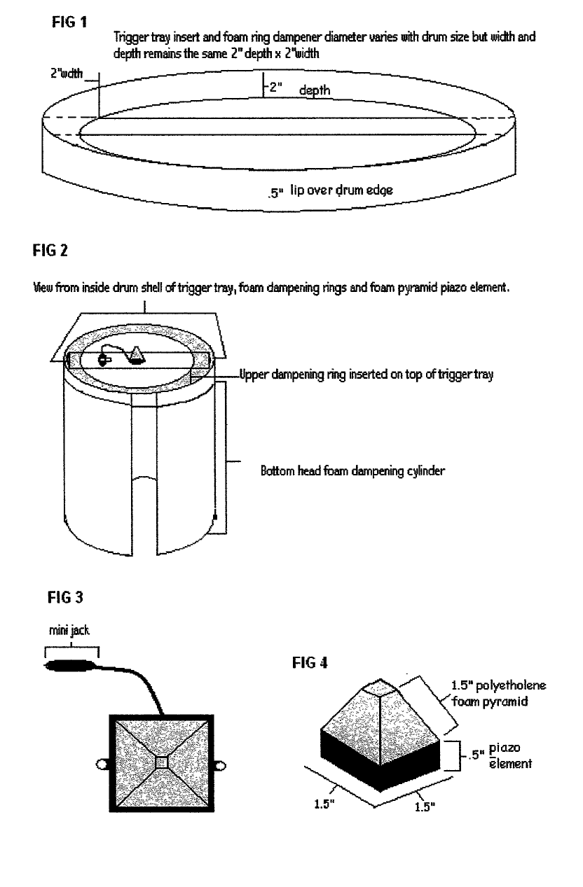

Initially the embodiment of the present invention is shown in FIGS. 1-4 for installation into a randomly sized cylindrical acoustical drum. It should be understood that this is for ease of explanation and that the size and shape of the acoustic drum in the figures are not to be construed as being so limited.

While the invention as been described in connection with the preferred embodiment, it is not intended to limit the scope of the invention to the particular form set forth, but on the contrary, it is intended to cover such alternatives, modifications and equivalents as may be included within the spirit and scope of the invention as defined by the appended claims.

1. A device used to convert acoustic drum strikes into electronic impulses which can be transmitted to an electronic device that converts the impulses to sound without loosing the natural feel of creating a drum strike. A device which mounts on a acoustic drum for more position sensitive transmission of drum impulses by reducing the impulse receiving (trigger) and dampening area. A device that allows for a more accurate drum feel in acoustic triggered drums by use of a dampening ring on the top head and reduced trigger surface area. A device that allows for personalized selection of dampening qualities of a acoustic triggered drum.
